(19) United States
(12) Patent Application Publication
(10) Pub. No.: US 2024/0396690 A1
(43) Pub. Date: Nov. 28, 2024

(54) TERMINAL AND WIRELESS COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Haruhi Echigo, Tokyo (JP)

(73) Assignee: NTT DOCOMO, INC., Tokyo (JP)

(21) Appl. No.: 18/695,274

(22) PCT Filed: Sep. 30, 2021
(86) PCT No.: PCT/JP2021/036254

§ 371 Date: Mar. 25, 2024

(51) Int. Cl. H04L 5/00

(52) U.S. Cl. CPC H04L 5/0051; H04L 5/0094

(57) ABSTRACT

A terminal according to the present invention comprises: a reception unit that receives control information; and a control unit that controls the transmission of an uplink control signal including a reference signal allocated across multiple transmission time units on the basis of the control information.

### TECHNICAL FIELD

The present disclosure relates to a terminal and a radio communication method.

### BACKGROUND ART

The 3rd Generation Partnership Project (3GPP) has specified the 5th generation mobile communication system (also referred to as 5G, New Radio (NR), or Next Generation (NG)), and has been further working on the specification of the next generation called Beyond 5G, 5G Evolution, or 6G.

For example, agreement has been reached in 3GPP Release-17 (hereinafter referred to as RE1-17) on Coverage Enhancement (Coverage Extension, CE) in NR (e.g., see Non-Patent Literature (hereinafter referred to as “NPL”) 1).

### CITATION LIST

### Non-Patent Literature

NPL 1
“New WID on NR coverage enhancements,” RP-202928, 3GPP TSG RAN meeting #90e, Electronic Meeting, Dec. 7-11, 2020”

### SUMMARY OF INVENTION

### Technical Problem

There is scope for further study on improvement of the performance of signal processing based on a reference signal (e.g., Demodulation Reference Signal (DMRS)) in the NR Coverage Enhancement.

An aspect of the present disclosure is to provide a terminal and a radio communication method each capable of improving the performance of signal processing based on a reference signal.

A terminal according to an aspect of the present disclosure includes: a reception section that receives control information; and a control section that controls, based on the control information, transmission of an uplink control signal that includes a reference signal mapped over a plurality of transmission time units.

A radio communication method according to an aspect of the present disclosure includes: receiving control information by a terminal; and controlling, by the terminal based on the control information, transmission of an uplink control signal that includes a reference signal mapped over a plurality of transmission time units.

### BRIEF DESCRIPTION OF DRAWINGS

FIG. 1 illustrates an exemplary radio communication system according to an embodiment;

FIG. 2 illustrates exemplary frequency ranges used in the radio communication system;

FIG. 3 illustrates configuration examples of a radio frame, s sub frame, and a slot used in the radio communication system;

FIG. 4 illustrates an exemplary RRC information element in Opt. 1 of Proposal 1;

FIG. 5 illustrates the first example of an RRC information element of Proposal 2-1;

FIG. 6 illustrates an exemplary RRC information element of Proposal 2-2;

FIG. 7 illustrates an exemplary RRC information element in Opt. 1 of Proposal 3-1;

FIG. 8 illustrates an exemplary RRC information element in Opt. 1 of Proposal 3-2;

FIG. 9 is a block diagram illustrating an exemplary configuration of a base station according to the present embodiment;

FIG. 10 is a block diagram illustrating an exemplary configuration of a terminal according to the present embodiment; and

FIG. 11 illustrates an exemplary hardware configuration of the base station or the terminal according to the present embodiment.

### DESCRIPTION OF EMBODIMENTS

Hereinafter, an embodiment according to an aspect of the present disclosure will be described in detail with reference to the accompanying drawings.

### EMBODIMENT

### 1. Overall Schematic Configuration of Radio Communication System

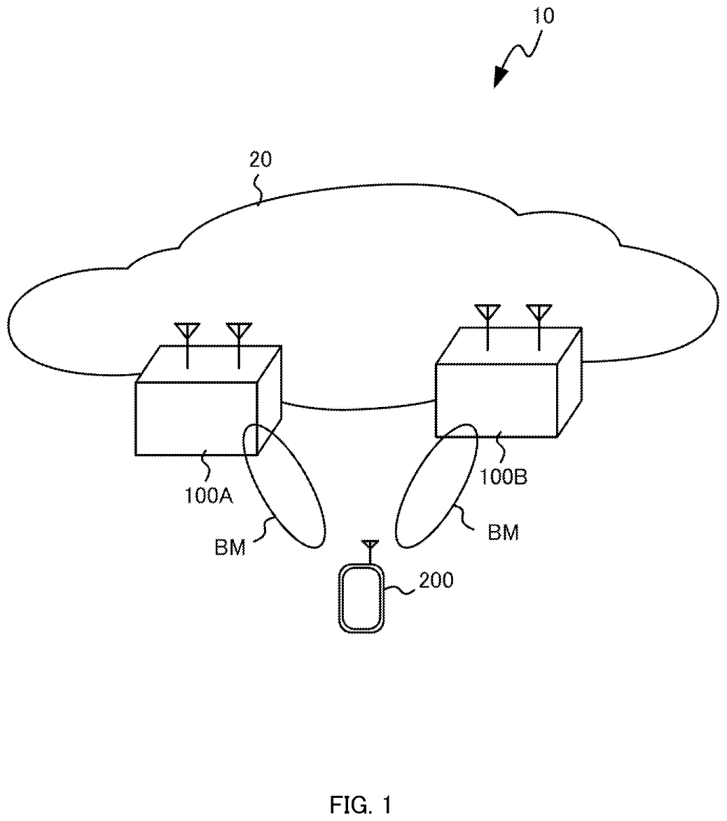

FIG. 1 illustrates an example of radio communication system 10 according to an embodiment. Radio communication system 10 is a radio communication system conforming to 5G New Radio (NR), and includes Next Generation-Radio Access Network 20 (hereinafter, NG-RAN 20) and terminal 200 (hereinafter, may also be referred to as user equipment (UE) 200).

Note that radio communication system 10 may be a radio communication system conforming to a scheme called Beyond 5G, 5G Evolution, or 6G.

NG-RAN 20 includes base stations 100 (in FIG. 1, base station 100A (hereinafter, may also be referred to as gNB 100A) and base station 100B (hereinafter, may also be referred to as gNB 100B)). Note that the numbers of gNBs and UEs are not limited to those in the example illustrated in FIG. 1.

NG-RAN 20 actually includes a plurality of NG-RAN nodes, specifically, gNBs (or ng-eNBs), and connects to a core network conforming to 5G (5GC, not illustrated). Note that NG-RAN 20 and 5GC may be simply expressed as a “network.”

gNB 100A and gNB 100B are base stations conforming to 5G, and perform radio communication conforming to 5G with UE 200. gNB 100A, gNB 100B, and UE 200 may support, by controlling radio signals transmitted from a plurality of antenna elements, for example, Massive MIMO for generating a beam BM with higher directivity, carrier aggregation (CA) for using a plurality of component carriers (CCs) aggregated together, and dual connectivity (DC) for performing communication with two or more transport blocks simultaneously, between the UE and each of the two NG-RAN nodes. Note that the term MIMO is an abbreviation for Multiple-Input Multiple-Output.

Further, radio communication system 10 supports a plurality of frequency ranges (FRs).

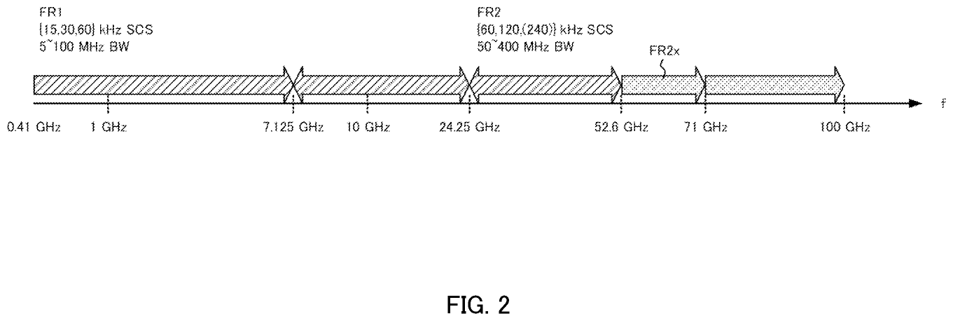

FIG. 2 illustrates exemplary frequency ranges used in radio communication system 10. As illustrated in FIG. 2, radio communication system 10 supports FR1 and FR2. The frequency band of each FR is as follows.
FR1: 410 MHz to 7.125 GHz
FR2: 24.25 GHz to 52.6 GHz

FR1 may use sub-carrier spacing (SCS) of 15, 30, or 60 kHz, and may use a bandwidth (BW) of 5 to 100 MHz. FR2 uses frequency higher than FR1. FR2 may use the SCS of 60 or 120 kHz (240 kHz may also be included), and may use a bandwidth (BW) of 50 to 400 MHz.

Note that the term SCS is an abbreviation for Sub-Carrier Spacing. The SCS may be interpreted as numerology. The numerology is defined in 3GPP TS 38.300, and corresponds to a single sub-carrier spacing in frequency domain.

Radio communication system 10 may further support a frequency band higher than that of FR2. To be more specific, radio communication system 10 may support a frequency band up to 114.25 GHz exceeding 52.6 GHz. Such high frequency band may be referred to as “FR2x” for convenience.

In order to solve such a problem, when a band exceeding 52.6 GHz is used, CP-OFDM/DFT-S-OFDM, which have larger SCS, may be applied. Note that the term CP-OFDM is an abbreviation for Cyclic Prefix-Orthogonal Frequency Division Multiplexing, and the term DFT-S-OFDM is an abbreviation for Discrete Fourier Transform-Spread-Orthogonal Frequency Division Multiplexing.

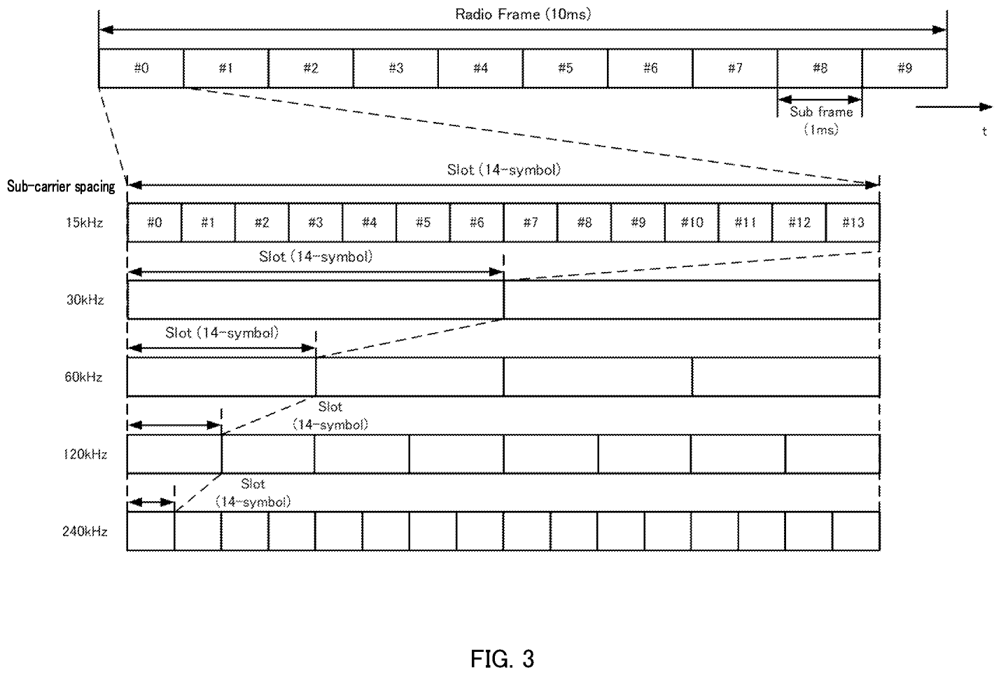

FIG. 3 illustrates configuration examples of a radio frame, a subframe, and a slot used in radio communication system 10. As illustrated in FIG. 3, a single slot is composed of 14 symbols. The larger (broader) the SCS is, the shorter a symbol duration (and slot duration) is. The SCS is not limited to the spacings (frequencies) illustrated in FIG. 3, however. For example, 480 kHz and 960 kHz may be used as the SCS.

In addition, the number of symbols composing a single slot is not necessarily 14 symbols (may be 28 or 56 symbols, for example). Further, the number of slots per subframe may be different for each SCS.

Note that the time direction (t) illustrated in FIG. 3 may be referred to as time domain, a symbol duration, or symbol time, for example. Additionally, the frequency direction may be referred to as frequency domain, a resource block, a subcarrier, a bandwidth part (BWP), for example.

A DMRS is a type of reference signal and is prepared for various channels. For example, the DMRS is used for any of an uplink control channel (e.g., PUCCH), an uplink data channel (e.g., PUSCH), a downlink control channel (e.g., PDCCH), and a downlink data channel (e.g., PDSCH). Note that the term DMRS is an abbreviation for Demodulation Reference Signal. The term PUCCH is an abbreviation for Physical Uplink Control Channel. The term PUSCH is an abbreviation for Physical Uplink Shared Channel. The term PDCCH is an abbreviation for Physical Downlink Control Channel. The term PDSCH is an abbreviation for Physical Downlink Shared Channel.

The DMRS may be used for channel estimation in UE 200 and/or channel estimation in base station 100, as a device, e.g., part of coherent demodulation.

Incidentally, the radio communication system performs channel estimation of PDSCH (or PDCCH) for each slot in downlink, using a DMRS. For example, base station 100 transmits a PDSCH (or PDCCH) signal including a DMRS, and UE 200 performs, in reception processing of the PDSCH (or PDCCH) signal, channel estimation based on the DMRS and then performs demodulation processing based on an estimation result.

Moreover, the radio communication system performs channel estimation of PUSCH (or PUCCH) for each slot in uplink, using a DMRS. For example, UE 200 transmits a PUSCH (or PUCCH) signal including a DMRS, and base station 100 performs, in reception processing of the PUSCH (or PUCCH) signal, channel estimation based on the DMRS and then performs demodulation processing based on an estimation result.

In addition, although the radio communication system can perform channel estimation of PUSCH (or Physical Uplink Control Channel (PUCCH)) using a demodulation reference signal (DMRS) for each slot, the radio communication system can further perform channel estimation of PUSCH (or PUCCH) using a DMRS assigned to each of multiple slots. Such channel estimation may be referred to as “Joint channel estimation.” Alternatively, it may be referred to by another name, such as cross-slot channel estimation.

Incidentally, the Joint channel estimation performs processing (e.g., channel estimation processing) by bundling DMRSs assigned to multiple slots, respectively. The Joint channel estimation is channel estimation processing based on DMRS bundling. The term “Joint channel estimation” may be replaced with the term “DMRS bundling.” Note that the target of the Joint channel estimation is not limited to the DMRSs assigned to the plurality of slots, respectively. For example, the target of the Joint channel estimation may be DMRSs assigned to a plurality of frames (or subframes), respectively.

UE 20 may transmit the DMRSs assigned (over) multiple slots, such that base station 100 can perform the joint channel estimation using the DMRS.

The Joint channel estimation is not limited to being applied in uplink and may also be applied in downlink. In this case, base station 100 may transmit the DMRSs assigned (over) multiple slots, such that UE 200 can perform the joint channel estimation using the DMRS.

The DMRS may have a plurality of mapping types. Specifically, the DMRS has mapping type A and mapping type B. In mapping type A, the first DMRS is placed in (mapped to) the second or third symbol of a slot. In mapping type A, a DMRS may be mapped relative to a slot boundary, regardless of where the actual data transmission starts in the slot. The reason that the first DMRS is placed in the second or third symbol of the slot may be interpreted as placing the first DMRS after a control resource set (control resource sets (CORESETs)).

In mapping type B, the first DMRS may be placed in the first symbol of data assignment. That is, a position of a DMRS may be given relative to a position to which the data is placed, not relative to the slot boundary.

The DMRS may also have a plurality of types (Types). Specifically, the DMRS has Type 1 and Type 2. Type 1 and Type 2 are different from each other in mapping and the maximum number of orthogonal reference signals in frequency domain. Type 1 can output up to four orthogonal signals in a single-symbol DMRS, whereas Type 2 can output up to eight orthogonal signals in double-symbol DMRS.

Note that DMRSs in the DMRS bundling to be described below may or may not follow any of the plurality of mapping types mentioned above. In addition, DMRSs in the DMRS bundling to be described below may or may not follow the arrangement (mapping) and Types mentioned above.

The radio communication system may support Coverage Enhancement (Coverage Extension, CE) for extending a coverage of a cell (or may be a physical channel) formed by base station 100. In the coverage enhancement, a mechanism for increasing the reception success rate of various physical channels may be provided.

For example, the Joint channel estimation mentioned above (e.g., DMRS bundling) has been studied aiming at coverage characteristic enhancement of PUSCH and PUCCH.

In the Joint channel estimation, since the channel estimation of PUSCH (or PUCCH) is performed using a DMRS assigned to each of multiple slots, the estimation accuracy can be improved as compared with the channel estimation based on the DMRS in a single slot, and the data demodulation accuracy can be also improved, thereby improving the characteristic and coverage of channel estimation, for example.

For example, the Joint channel estimation (e.g., DMRS bundling) has been discussed and designed aiming at coverage characteristic enhancement of PUSCH. In addition, as for PUCCH, it has been studied to follow a design of PUSCH to the extent possible.

For example, as for PUSCH, the following design has been agreed.

In joint channel estimation for PUSCH repetition type A of PUSCH repetition of the same transport block (TB), all of the repetition is covered by one or a plurality of consecutive time-domain windows (TDWs) or one or a plurality of non-consecutive TDWs. Herein, the TDW is configured by higher layer signaling (e.g., Radio Resource Control (RRC) signaling).

Each of configured TDWs is composed of one or a plurality of consecutive physical slots.

A window length L of the configured TDW may be explicitly set to a single value.

Note that there is room for study on the maximum value of L. Moreover, there is room for study on error propagation that is caused when Lis longer than the maximum value. Furthermore, there is room for study on whether the window length L is configured per BWP in UL.

Here, with respect to the configuration for PUCCH, e.g., the configuration of DMRS bundling for PUCCH, the following two configurations are studied:
Configure DMRS bundling for PUCCH to Enable or disable; and
Configure parameter, L, that indicates the window length (or size) of a TDW of the DMRS bundling for PUCCH.

Thus, in the present embodiment, a method that makes the above-mentioned two configurations possible will be described. Illustratively, in the following, the above-mentioned configurations are realized by RRC signaling, which is an example of higher layer signaling.

Note that configuring the DMRS bundling for PUCCH to Enable or disable may be referred to as configuring Enabling/disabling of the DMRS bundling for PUCCH. Configuring the DMRS bundling for PUCCH to Enable may be replaced by another expression such as enabling or making available the DMRS bundling for PUCCH. Meanwhile, configuring the DMRS bundling for PUCCH to disable may be replaced by another expression such as disabling or making unavailable the DMRS bundling for PUCCH

Hereinafter, the phrase “Enabling/disabling of the DMRS bundling for PUCCH” may be abbreviated simply as Enabling/disabling or Enable/disable. Moreover, the phrase “L that indicates the window length of a TDW of the DMRS bundling for PUCCH” may be abbreviated as “L of the DMRS bundling for PUCCH” or “L.” For example, configuring Enabling/disabling and L is equivalent to configuring Enabling/disabling of the DMRS bundling for PUCCH, and L that indicates the window length of a TDW of the DMRS bundling for PUCCH. Note that L indicating the window length of the TDW may be represented by the number of slots or the number of other time units (e.g., frames or subframes).

In the present embodiment, descriptions will be given of the following points on the configurations of Enabling/disabling of the DMRS bundling for PUCCH and L of the DMRS bundling for PUCCH.

### (Proposal 1)

Enabling/disabling of the DMRS bundling for PUCCH and L of the DMRS bundling for PUCCH are configured for each BWP. In Proposal 1, either of the following two options (hereinafter sometimes abbreviated as Opt) may be applied:
Opt.1: Enabling/disabling and L are configured separately; and
Opt.2: Enabling/disabling and L are configured in one indication.

### (Proposal 2)

Enabling/disabling of the DMRS bundling for PUCCH is configured for each BWP, whereas L is configured for each PUCCH format or for each PUCCH resource.

### (Proposal 3)

Enabling/disabling and L of the DMRS bundling for PUCCH are configured for each PUCCH format or for each PUCCH resource.

### (Proposal 4)

Enabling/disabling of the DMRS bundling for PUCCH is configured for each PUCCH format or for each PUCCH resource, whereas L is configured for each BWP.

### (Proposal 5)

UE 200 reports the Capability on the response availability to configuration of PUCCH DMRS bundling.

The proposals will be each described below.

### (Proposal 1)

In Proposal 1, Enabling/disabling of the DMRS bundling for PUCCH and L of the DMRS bundling for PUCCH are configured for each BWP. For example, information on the configurations of Enabling/disabling and L is included in information on configuration of PUCCH. For example, the information on the configurations of Enabling/disabling and L is included in information referred to as PUCCH-Config IE. The PUCCH-Config IE is an information element indicated by RRC signaling and is configured for each BWP. The information on the configurations of Enabling/disabling and L may be included in a PUCCH-FormatConfig field of the PUCCH-Config IE. In this case, Enabling/disabling and L are configured using the PUCCH-FormatConfig field of the PUCCH-Config IE.

For example, UE 200 receives the information on the configuration of PUCCH via higher layer signaling (e.g., RRC signaling) and configures, based on the received information, Enabling/disabling of the DMRS bundling for PUCCH and L of the DMRS bundling for PUCCH.

The information on the configuration of Enabling/disabling (hereinafter also referred to as “information on Enabling/disabling configuration”) may be replaced with another expression such as information for configuring Enabling/disabling or information indicating Enabling/disabling. Moreover, the information on the configuration of L (hereinafter also referred to as “information on L configuration”) may be replaced with another expression such as information for configuring L or information indicating L. Besides, in the following, information may be included in a storage place of information referred to as a field.

Either of the following Option 1 (hereinafter abbreviated as Opt. 1) or Option 2 (hereinafter abbreviated as Opt. 2) may be applied to the configuration in Proposal 1.

Opt.1: Enabling/disabling and L are configured separately. For example, Enabling/disabling and L can be configured separately by causing the information on the Enabling/disabling configuration and the information on the L configuration to be included in the PUCCH-FormatConfig field.

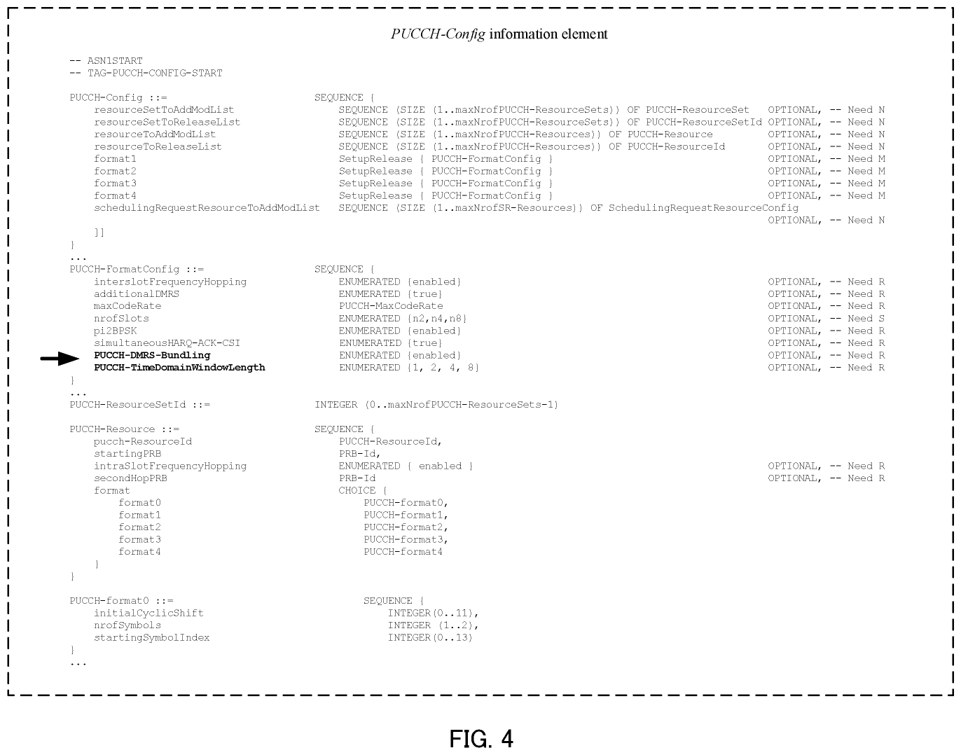

FIG. 4 illustrates an exemplary information element of RRC in Opt. 1 of Proposal 1. FIG. 4 illustrates fields included in a PUCCH-Config information element (IE). By way of example, FIG. 4 illustrates a “PUCCH-Config” field, a “PUCCH-FormatConfig” field, a “PUCCH-Resource” field, and a “PUCCH-format 0” field.”

Note that the PUCCH-Config information element (IE) illustrated in FIG. 4 is an example, and the present disclosure is not limited to this. For example, in the PUCCH-Config information element may have a field that is not included in FIG. 4, or some of the fields illustrated in FIG. 4 may be omitted.

The “PUCCH-DMRS-Bundling” field indicated by the arrow in FIG. 4 is a field including the information on the Enabling/disabling configuration of the DMRS bundling for PUCCH. In FIG. 4, the PUCCH-DMRS-Bundling field is included in the PUCCH-FormatConfig field. In the following, the PUCCH-DMRS-Bundling field is regarded as an example of the information on the Enabling/disabling configuration of the DMRS bundling for PUCCH. Further, inclusion of a field including information A in a field including information B may be equivalent to information A being included in information B.

Incidentally, the PUCCH-Config information element is information configured for each BWP. Enabling/disabling of the DMRS bundling for PUCCH is configured for each BWP by causing the PUCCH-DMRS-Bundling field to be included in the PUCCH-FormatConfig field.

For example, inclusion of the PUCCH-DMRS-Bundling field in the PUCCH-FormatConfig field may indicate that the DMRS bundling for PUCCH is Enabling, whereas no inclusion of the PUCCH-DMRS-bundling field in the PUCCH-FormatConfig field may indicate that the DMRS bundling for PUCCH is disabling. Alternatively, when the PUCCH-DMRS-Bundling field included in the PUCCH-FormatConfig field is set to a first value (e.g., value indicating enable), it may indicate that the DMRS bundling for PUCCH is Enabling, whereas when the PUCCH-DMRS-Bundling field is set to a second value different from the first value (e.g., value indicating disable), it may indicate that the DMRS bundling for PUCCH is disabling.

The “PUCCH-TimeDomainWindowLength” field indicated by the arrow in FIG. 4 is a field including information on the L configuration of the DMRS bundling for PUCCH. In the following, the PUCCH-TimeDomainWindowLength field is regarded as an example of the information on the L configuration of the DMRS bundling for PUCCH.

For example, the PUCCH-TimeDomainWindowLength field is configured with a value of L of the DMRS bundling for PUCCH. In the example of FIG. 4, the PUCCH-TimeDomainWindowLength field is configured with any value of 1, 2, 4, and 8. The present disclosure is not limited to, however, the example of configuration with any of 1, 2, 4, and 8. In other words, the present disclosure is not limited to the example in which candidate values for L are 1, 2, 4, and 8. Any of 1, 2, 4, and 8 need not be included in the candidate values for L. Alternatively, the candidate values for L may include a value other than 1, 2, 4, and 8. The candidate values for L may include zero. For example, when the PUCCH-DMRS-Bundling field indicates disabling of the DMRS bundling for PUCCH, the PUCCH-TimeDomainWindowLength field is configured with zero.

Opt. 2: Enabling/disabling and L are configured in one indication (or information).

For example, the presence or absence of the L configuration includes the Enabling/disabling configuration. The presence of the L configuration may correspond to Enable, and the absence of the L configuration may correspond to disable. The presence of the L configuration may be equivalent to inclusion of the information on the L configuration in the PUCCH-FormatConfig field, and the absence of the L configuration may be equivalent to no inclusion of the information on the L configuration in the PUCCH-FormatConfig field. Alternatively, the absence of the L configuration may be equivalent to the inclusion of the information on the L configuration in the PUCCH-FormatConfig field and indication of zero by the information on the L configuration.

Otherwise, for example, the Enabling/disabling configuration includes the L configuration. For example, when the information on the Enabling/disabling configuration indicates “Enable,” the L configuration may be enabled, and when the information on the Enabling/disabling configuration indicates “disable,” the L configuration may be disabled. In this example, the L configuration, e.g., the value of L may be defined by specifications or may be in accordance with a UE capability. For example, when the information on the Enabling/disabling configuration indicates “Enable,” UE 200 applies the value of L defined by specifications or the value of L indicated by the UE Capability, thus performing the DMRS bundling.

Incidentally, a value of L that varies for each BWP may be defined by specifications. Alternatively, a value of L that varies for each BWP may be indicated by a UE Capability. Whether the value of L defined by specifications is used or the value of L indicated by the UE capability is used may be different for each BWP. For example, the PUCCH-FormatConfig field may include information indicating whether the value of L defined by specifications is used or the value of L indicated by the UE capability is used.

As described above, Proposal 1 has indicated the example in which Enabling/disabling of the DMRS bundling for PUCCH and L of the DMRS bundling for PUCCH are configured for each BWP. This allows the PUCCH DMRS bundling to be configured for each BWP, thus improving the performance of signal processing based on a DMRS. Further, the configuration for each BWP makes it possible to change, for each BWP, configuration for processing of the DMRS bundling, thus performing an appropriate configuration for each BWP.

### (Proposal 2)

In Proposal 2, Enabling/disabling of the DMRS bundling for PUCCH is configured for each BWP, whereas L is configured for each PUCCH format or for each PUCCH resource.

For example, the information on the Enabling/disabling configuration is included in a PUCCH-FormatConfig field of a PUCCH-Config IE, and the information on the L configuration is included in a PUCCH-Resource field or a PUCCH format field. In this case, Enabling/disabling is configured using the PUCCH-FormatConfig field of the PUCCH-Config IE. Meanwhile, L is configured using the PUCCH-Resource field or the PUCCH format field.

Illustratively, Proposal 2 includes the following two variations:
Enabling/disabling is configured for each BWP, whereas L is configured for each PUCCH format (hereinafter referred to as Proposal 2-1); and
Enabling/disabling is configured for each BWP, whereas L is configured for each PUCCH resource (hereinafter referred to as Proposal 2-2).

The variations will be each described below.

### (Proposal 2-1)

In Proposal 2-1, Enabling/disabling of the DMRS bundling for PUCCH is configured for each BWP, whereas L is configured for each PUCCH format. For example, the information on the Enabling/disabling configuration is included in a PUCCH-FormatConfig field of a PUCCH-Config IE, and the information on the L configuration is included in a PUCCH format field of the PUCCH-Config IE. In this case, Enabling/disabling is configured using the PUCCH-FormatConfig field of the PUCCH-Config IE, and L is configured using the PUCCH format field.

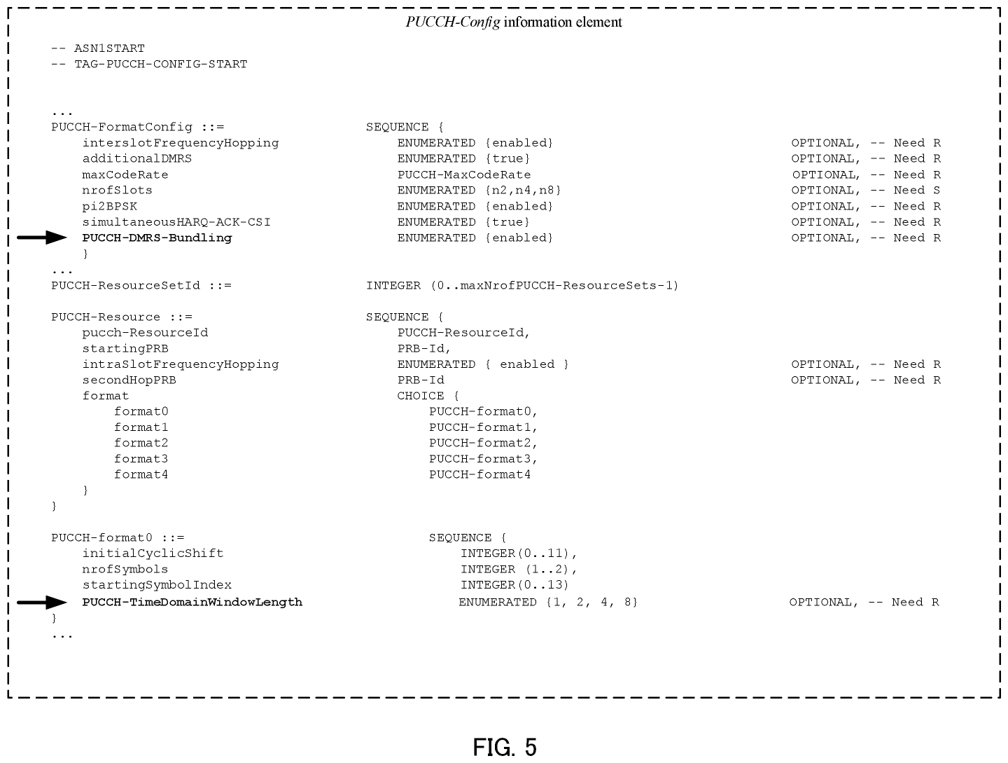

FIG. 5 illustrates the first example of an information element of RRC of Proposal 2-1. FIG. 5 illustrates fields included in a PUCCH-Config information element, as in FIG. 4.

As in FIG. 4, the PUCCH-DMRS-Bundling field of FIG. 5 is information on the Enabling/disabling configuration of the DMRS bundling for PUCCH, and the PUCCH-TimeDomainWindowLength field is information on the L configuration of the DMRS bundling for PUCCH.

In FIG. 5, the PUCCH-DMRS-Bundling field is included in the PUCCH-FormatConfig field, as in FIG. 4. Therefore, Enabling/disabling of the DMRS bundling for PUCCH is configured for each BWP.

In FIG. 5, the PUCCH-TimeDomainWindowLength field is included in a PUCCH-format 0 field. The PUCCH-format 0 field is information on configuration of PUCCH format 0. In FIG. 5, although omitted, the PUCCH-Config IE may include information on configuration of a PUCCH format different from PUCCH format 0 (e.g., PUCCH format 1, PUCCH format 2, PUCCH format 3, or PUCCH format 4). Further, the PUCCH-TimeDomainWindowLength field may be included in a field of the PUCCH format different from PUCCH format 0. Since the fields of PUCCH format 0 and another PUCCH format are information on the configuration for each PUCCH format, L is configured for each PUCCH format by causing the TimeDomainWindowLength field to be included in a PUCCH format field.

Incidentally, the TimeDomainWindowLength field may be included in each of the PUCCH format fields that configure a plurality of PUCCH formats (e.g., PUCCH format 0, PUCCH format 1, PUCCH format 2, PUCCH format 3, and PUCCH format 4). Alternatively, a PUCCH format field including the TimeDomainWindowLength field and a PUCCH format field not including the TimeDomainWindowLength field may coexist. By way of example, a field of PUCCH format 0 may include the TimeDomainWindowLength field, and a field of PUCCH format 1 may not include the TimeDomain WindowLength field.

Further, possible values of L (e.g., candidate values for L) may be different or the same for each PUCCH format. For example, in the example of FIG. 5, the possible values of the TimeDomainWindowLength field (e.g., candidate values for L) included in the field of PUCCH format 0 are 1, 2, 4, and 8. Further, for example, the possible values of the TimeDomainWindowLength field (e.g., candidate values for L) included in the field of PUCCH format 1 may include a value other than 1, 2, 4, and 8, or may not include any of 1, 2, 4, and 8.

Besides, a PUCCH format including the TimeDomainWindowLength field may be specified as a new PUCCH format with respect to conventional PUCCH formats. For example, while FIG. 5 illustrates an example in which the TimeDomainWindowLength field is included in PUCCH format 0, a PUCCH format obtained by adding the TimeDomain WindowLength field to PUCCH format 0 may be newly specified as PUCCH format x (x is, e.g., integer of 5 or more), as in FIG. 5.

Incidentally, in a PUCCH format field, the number of Repetitions of PUCCH and/or the number of slots for Inter slot frequency hopping may be configured, together with L. The number of Repetitions of PUCCH indicates the number of Repetitions when a transmission method for Repetition transmission of PUCCH is applied. The Inter slot frequency hopping indicates the number of slots with which frequency hopping is possible when a communication method that performs the frequency hopping between slots is applied.

Information on configuration of the number of Repetitions of PUCCH and/or information on configuration of the number of slots for the Inter slot frequency hopping may be included in a PUCCH format field.

Alternatively, the number of Repetitions of PUCCH and/or the number of slots for the Inter slot frequency hopping may be the same value as L. When the number of Repetitions of PUCCH is the same value as L, the number of Repetitions of PUCCH need not be explicitly indicated. In other words, when the number of Repetitions of PUCCH is the same value as L, the information on the configuration of the number of Repetitions of PUCCH need not be included in a PUCCH format field. Moreover, when the number of slots for the Inter slot frequency hopping is the same value as L, the number of slots for the Inter slot frequency hopping need not be explicitly indicated. When the number of slots for the Inter slot frequency hopping is the same value as L, the information on the configuration of the number of slots for the Inter slot frequency hopping need not be included in a PUCCH format field.

Alternatively, L may be the same value as the number of Repetitions of PUCCH or the number of slots for the Inter slot frequency hopping. In this case, L need not be explicitly indicated. In other words, in this case, the TimeDomainWindowLength field need not be included in a PUCCH format field.

Alternatively, the number of Repetitions of PUCCH, the number of slots for the Inter slot frequency hopping, and L may be identical with each other. In this case, at least one of the information on the configuration of the number of Repetitions of PUCCH, the information on the configuration of the number of slots for the Inter slot frequency hopping, and the information on the L configuration (e.g., TimeDomainWindowLength field) may be included in a PUCCH format field.

As described above, Proposal 2-1 has indicated the example in which Enabling/disabling of the DMRS bundling for PUCCH is configured for each BWP, whereas L is configured for each PUCCH format. This allows the PUCCH DMRS bundling to be configured, thus improving the performance of signal processing based on a DMRS. Further, the configuration of L for each PUCCH format makes it possible to change, for each PUCCH format, configuration for processing of the DMRS bundling, thus performing an appropriate configuration for each PUCCH format.

### (Proposal 2-2)

In Proposal 2-2, Enabling/disabling of the DMRS bundling for PUCCH is configured for each BWP, whereas L is configured for each PUCCH resource. For example, the information on the Enabling/disabling configuration is included in a PUCCH-FormatConfig field of a PUCCH-Config IE, and the information on the L configuration is included in a PUCCH-Resource field of the PUCCH-Config IE. In this case, Enabling/disabling is configured using the PUCCH-FormatConfig field of the PUCCH-Config IE, and L is configured using the PUCCH-Resource field.

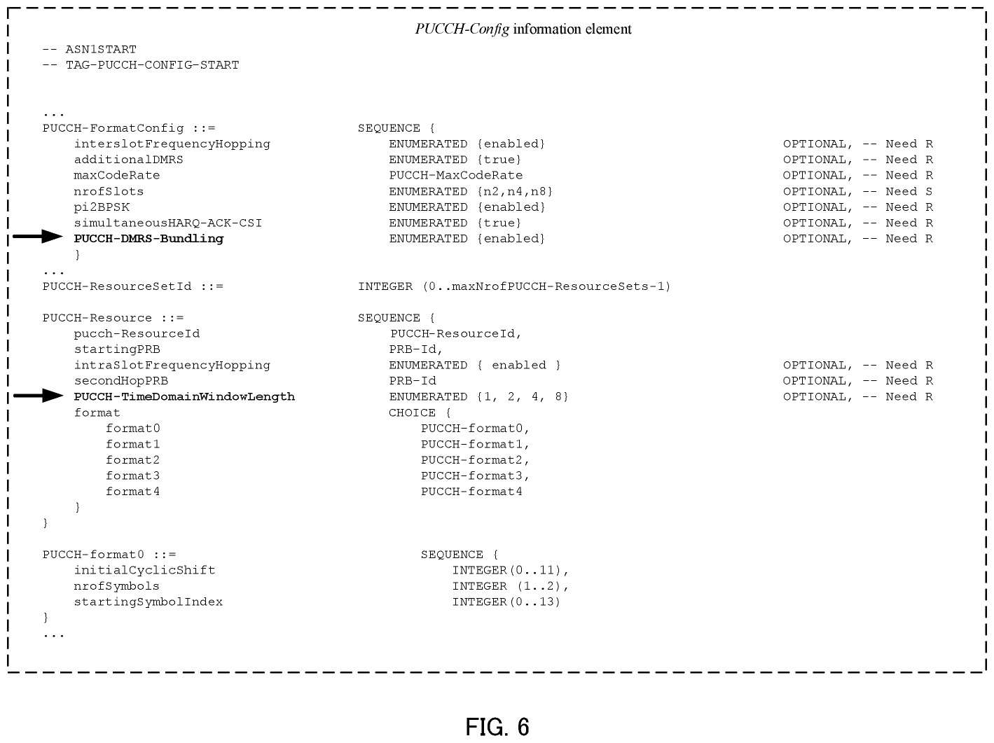

FIG. 6 illustrates an exemplary information element of RRC of Proposal 2-2. In FIG. 6 illustrates fields included in a PUCCH-Config information element, as in FIG. 4.

As in FIG. 4, the PUCCH-DMRS-Bundling field of FIG. 6 is information on the Enabling/disabling configuration of the DMRS bundling for PUCCH, and the PUCCH-TimeDomainWindowLength field is information on the L configuration of the DMRS bundling for PUCCH.

In FIG. 6, the PUCCH-DMRS-Bundling field is included in the PUCCH-FormatConfig field, as in FIG. 4. Therefore, Enabling/disabling of the DMRS bundling for PUCCH is configured for each BWP.

In FIG. 6, the PUCCH-TimeDomainWindowLength field is included in the PUCCH-Resource field. The PUCCH-Resource field is information on PUCCH resource configuration for each PUCCH resource (e.g., for each PUCCH Resource Id). L is configured for each PUCCH resource by causing the TimeDomainWindowLength field to be included in the PUCCH-Resource field.

Incidentally, the TimeDomainWindowLength field may be included in each of PUCCH-Resource fields that configure PUCCH resources different from each other. Alternatively, among the PUCCH-Resource fields that configure PUCCH resources different from each other, a PUCCH-Resource field including the TimeDomainWindowLength field and a PUCCH-Resource field not including the TimeDomainWindowLength field may coexist.

In addition, possible values of L (e.g., candidate values for L) may be different or the same for each PUCCH resource. For example, in the example of FIG. 6, the possible values of the TimeDomainWindowLength field (e.g., candidate values for L) included in the PUCCH-Resource field are 1, 2, 4, and 8. The possible values of the TimeDomainWindowLength field (e.g., candidate values for L) may include a value other than 1, 2, 4, and 8, for example.

Incidentally, in a PUCCH-Resource field, the number of Repetitions of PUCCH and/or the number of slots for Inter slot frequency hopping may be configured, together with L. Information on configuration of the number of Repetitions of PUCCH and/or information on configuration of the number of slots for the Inter slot frequency hopping may be included in a PUCCH-Resource field.

Alternatively, the number of Repetitions of PUCCH and/or the number of slots for the Inter slot frequency hopping may be the same value as L. When the number of Repetitions of PUCCH is the same value as L, the number of Repetitions of PUCCH need not be explicitly indicated. In other words, when the number of Repetitions of PUCCH is the same value as L, the information on the configuration of the number of Repetitions of PUCCH need not be included in a PUCCH-Resource field. Moreover, when the number of slots for the Inter slot frequency hopping is the same value as L, the number of slots for the Inter slot frequency hopping need not be explicitly indicated. In other words, when the number of slots for the Inter slot frequency hopping is the same value as L, the information on the configuration of the number of slots for the Inter slot frequency hopping need not be included in a PUCCH-Resource field.

Alternatively, L may be the same value as the number of Repetitions of PUCCH or the number of slots for the Inter slot frequency hopping. In this case, L need not be explicitly indicated. In other words, in this case, the TimeDomainWindowLength field need not be included in a PUCCH-Resource field.

Alternatively, the number of Repetitions of PUCCH, the number of slots for the Inter slot frequency hopping, and L may be identical with each other. In this case, at least one of the information for configuring the number of Repetitions of PUCCH, the information for configuring the number of slots for the Inter slot frequency hopping, and the information for configuring L (e.g., TimeDomainWindowLength field) may be included in a PUCCH-Resource field.

As described above, Proposal 2-2 has indicated the example in which Enabling/disabling of the DMRS bundling for PUCCH is configured for each BWP, and Lis configured for each PUCCH resource. This allows the PUCCH DMRS bundling to be configured, thus improving the performance of signal processing based on s DMRS.

Further, the configuration of L for each PUCCH resource makes it possible to change, for each PUCCH resource, configuration for processing of the DMRS bundling, thus performing an appropriate configuration for each PUCCH resource.

### (Proposal 3)

In Proposal 3, Enabling/disabling of the DMRS bundling for PUCCH and L of the DMRS bundling for PUCCH are configured for each PUCCH format or for each PUCCH resource.

For example, the information on the Enabling/disabling configuration is included in a PUCCH-Resource field or a PUCCH format field. The information on the L configuration is included in the PUCCH-Resource field or the PUCCH format field. In this case, Enabling/disabling and L are configured using the PUCCH-Resource field or the PUCCH format field.

Illustratively, Proposal 3 includes the following four variations:
Enabling/disabling and L are configured for each PUCCH format (hereinafter referred to as Proposal 3-1);
Enabling/disabling and L are configured for each PUCCH resource (hereinafter referred to as Proposal 3-2);
Enabling/disabling is configured for each PUCCH resource, and L is configured for each PUCCH format (hereinafter referred to as Proposal 3-3); and
Enabling/disabling is configured for each PUCCH format, and L is configured for each PUCCH resource (hereinafter referred to as Proposal 3-4).

The variations will be each described below.

### (Proposal 3-1)

In Proposal 3-1, Enabling/disabling of the DMRS bundling for PUCCH and L of the DMRS bundling for PUCCH are configured for each PUCCH format. For example, the information on the Enabling/disabling configuration and the information on the L configuration are included in a PUCCH-Format field of a PUCCH-Config IE.

Proposal 3-1 may include the following Option 1 and Option 2, as in Proposal 1.

Opt. 1: Enabling/disabling and L are configured separately. For example, Enabling/disabling and L can be configured separately by causing the information on the Enabling/disabling configuration and the information on the L configuration to be included in the PUCCH format field.

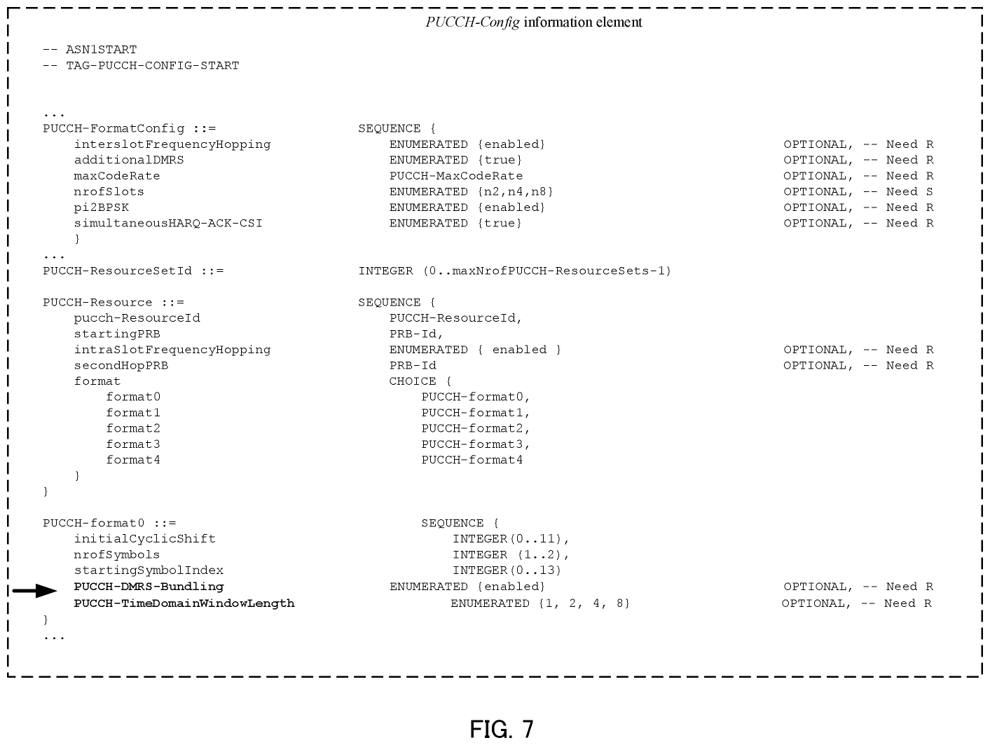

FIG. 7 illustrates an exemplary information element of RRC in Opt. 1 of Proposal 3-1. FIG. 7 illustrates fields included in a PUCCH-Config information element, as in FIG. 4.

In FIG. 7, a PUCCH-DMRS-Bundling field and a PUCCH-TimeDomain WindowLength field are included in a PUCCH-format 0 field. The PUCCH-format 0 field is information on configuration of PUCCH format 0. In FIG. 7, although omitted, the PUCCH-Config IE may include information on configuration of a PUCCH format different from PUCCH format 0. Further, the PUCCH-DMRS-Bundling field and the PUCCH-TimeDomainWindowLength field are included in a field of the PUCCH format different from PUCCH format 0. Since the fields of PUCCH format 0 and another PUCCH format are information on the configuration for each PUCCH format, Enabling/disabling and L are configured for each PUCCH format by causing the PUCCH-DMRS-Bundling field and the TimeDomainWindowLength field to be included in a PUCCH format field.

Incidentally, the PUCCH-DMRS-Bundling field and the TimeDomain WindowLength field may be included in each of the PUCCH format fields that configure a plurality of PUCCH formats. Alternatively, a PUCCH format field including the PUCCH-DMRS-Bundling field and the TimeDomain WindowLength field and a PUCCH format field not including the PUCCH-DMRS-Bundling field nor TimeDomainWindowLength field may coexist. Further, for example, a PUCCH format field including at least one of the PUCCH-DMRS-Bundling field and the TimeDomain WindowLength field but not including the other may be present.

In one example, the field of PUCCH format 0 may include the PUCCH-DMRS-Bundling field and the TimeDomainWindowLength field, whereas the field of PUCCH format 1 need not include the PUCCH-DMRS-Bundling field nor the TimeDomainWindowLength field. Moreover, the field of PUCCH format 2 may include the PUCCH-DMRS-Bundling field but need not include the TimeDomain WindowLength field. Moreover, the field of PUCCH format 3 need not include the PUCCH-DMRS-Bundling field but may include the TimeDomainWindowLength field.

Besides, as in Proposal 2-1 mentioned above, possible values of L (e.g., candidate values for L) may be different or the same for each PUCCH format.

Further, as in Proposal 2-1, a PUCCH format including the PUCCH-DMRS-Bundling field and the TimeDomainWindowLength field may be specified as a new PUCCH format with respect to conventional PUCCH formats. Alternatively, a PUCCH format including at least one of the PUCCH-DMRS-Bundling field and the TimeDomainWindowLength field may be specified as a new PUCCH format with respect to the conventional PUCCH formats.

Opt. 2: Enabling/disabling and L are configured in one indication (or information).

For example, the presence or absence of the L configuration includes the Enabling/disabling configuration. The presence of the L configuration may correspond to Enable, and the absence of the L configuration may correspond to disable. The presence of the L configuration may be equivalent to inclusion of the information on the L configuration in the PUCCH format field, and the absence of the L configuration may be equivalent to no inclusion of the information on the L configuration in the PUCCH format field. Alternatively, the absence of the L configuration may be equivalent to the inclusion of the information on the L configuration in the PUCCH format field and indication of zero by the information on the L configuration.

Otherwise, for example, the Enabling/disabling configuration includes the L configuration. For example, when the information on the Enabling/disabling configuration indicates “Enable,” the L configuration may be enabled, and when the information on the Enabling/disabling configuration indicates “disable,” the L configuration may be disabled. In this example, the L configuration, e.g., the value of L may be defined by specifications or may be in accordance with a UE capability. For example, when the information on the Enabling/disabling configuration indicates “Enable,” UE 200 applies the value of L defined by specifications or the value of L indicated by the UE Capability, thus performing the DMRS bundling.

Incidentally, a value of L that varies for each PUCCH format may be defined by specifications. Alternatively, a value of L that varies for each PUCCH format may be indicated by a UE Capability. Whether the value of L defined by specifications is used or the value of L indicated by the UE capability is used may be different for each PUCCH format. For example, the PUCCH format field may include information indicating whether the value of L defined by specifications is used or the value of L indicated by the UE capability is used.

In Proposal 3-1, in a PUCCH format field, the number of Repetitions of PUCCH and/or the number of slots for Inter slot frequency hopping may be configured, together with L, as in Proposal 2-1. Information on configuration of the number of Repetitions of PUCCH and/or information on configuration of the number of slots for the Inter slot frequency hopping may be included in the PUCCH format field.

### (Proposal 3-2)

In Proposal 3-2, Enabling/disabling of the DMRS bundling for PUCCH and L of the DMRS bundling for PUCCH are configured for each PUCCH resource. For example, the information on the Enabling/disabling configuration and the information on the L configuration are included in a PUCCH resource field of a PUCCH-Config IE.

Further, Proposal 3-2 may include the following Option 1 and Option 2, as in Proposal 1 and Proposal 3-1.

Opt.1: Enabling/disabling and L are configured separately. For example, Enabling/disabling and L can be configured separately by causing the information on the Enabling/disabling configuration and the information on the L configuration to be included in the PUCCH resource field.

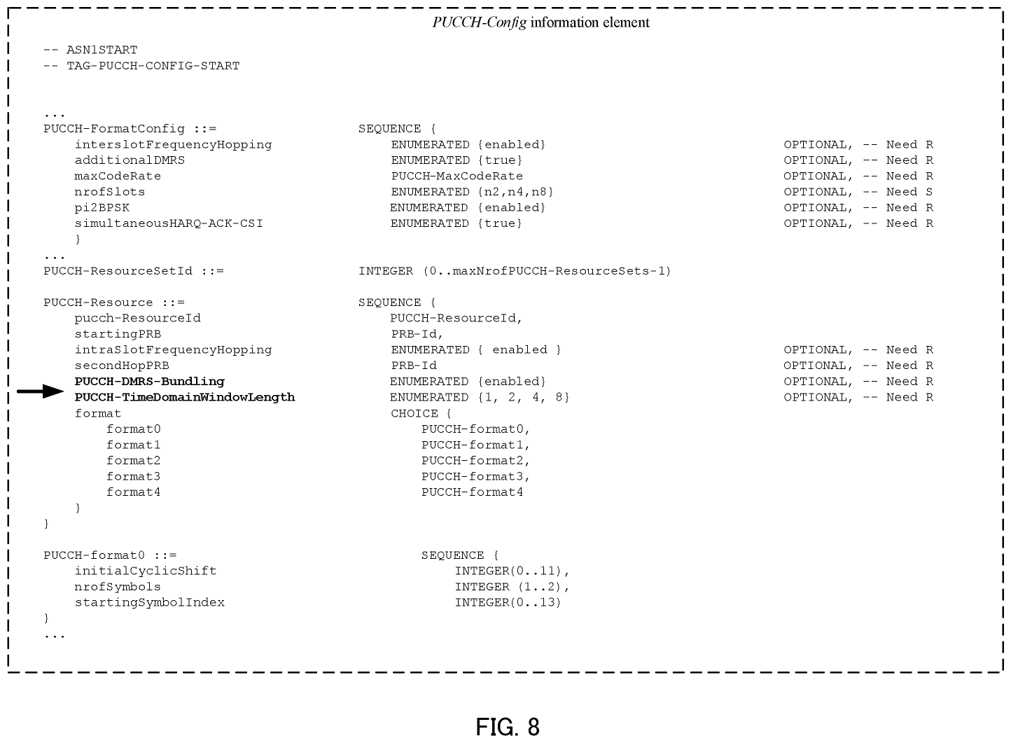

FIG. 8 illustrates an exemplary information element of RRC in Opt. 1 of Proposal 3-2. FIG. 8 illustrates fields included in a PUCCH-Config information element, as in FIG. 4.

In FIG. 8, a PUCCH-DMRS-Bundling field and a PUCCH-TimeDomainWindowLength field are included in a PUCCH-Resource field. Since the PUCCH-Resource field is information on the configuration for each PUCCH resource (e.g., for each PUCCH Resource Id), Enabling/disabling and L are configured for each PUCCH resource by causing the PUCCH-DMRS-Bundling field and the TimeDomain WindowLength field to be included in the PUCCH-Resource field.

Incidentally, the PUCCH-DMRS-Bundling field and the TimeDomainWindowLength field may be included in each of PUCCH-Resource fields that configure PUCCH resources different from each other. Alternatively, among the PUCCH-Resource fields that configure PUCCH resources different from each other, a PUCCH-Resource field including the PUCCH-DMRS-Bundling field and the TimeDomain WindowLength field and a PUCCH-Resource field not including the PUCCH-DMRS-Bundling field nor the TimeDomainWindowLength field may coexist. Further, for example, among the PUCCH-Resource fields that configure PUCCH resources different from each other, a PUCCH-Resource field including at least one of the PUCCH-DMRS-Bundling field and the TimeDomain WindowLength field but not including the other may be present.

In addition, as in Proposal 2-2 mentioned above, possible values of L (e.g., candidate values for L) may be different or the same for each PUCCH resource.

Opt. 2: Enabling/disabling and L are configured in one indication (or information).

For example, the presence or absence of the L configuration includes the Enabling/disabling configuration. The presence of the L configuration may correspond to Enable, and the absence of the L configuration may correspond to disable. The presence of the L configuration may be equivalent to inclusion of the information on the L configuration in the PUCCH-Resource field, and the absence of the L configuration may be equivalent to no inclusion of the information on the L configuration in the PUCCH-Resource field. Alternatively, the absence of the L configuration may be equivalent to the inclusion of the information on the L configuration in the PUCCH-Resource field and indication of zero by the information on the L configuration.

Otherwise, for example, the Enabling/disabling configuration includes the L configuration. For example, when the information on the Enabling/disabling configuration indicates “Enable,” the L configuration may be enabled, and when the information on the Enabling/disabling configuration indicates “disable,” the L configuration may be disabled. In this example, the L configuration, e.g., the value of L may be defined by specifications or may be in accordance with a UE capability. For example, when the information on the Enabling/disabling configuration indicates “Enable,” the terminal applies the value of L defined by specifications or the value of L indicated by the UE Capability, thus performing the DMRS bundling.

Incidentally, a value of L that varies for each PUCCH resource may be defined by specifications. Alternatively, a value of L that varies for each PUCCH resource may be indicated by a UE Capability. Whether the value of L defined by specifications is used or the value of L indicated by the UE capability is used may be different for each PUCCH resource. For example, the PUCCH resource field may include information indicating whether the value of L defined by specifications is used or the value of L indicated by the UE capability is used.

In Proposal 3-2, in a PUCCH-Resource field, the number of Repetitions of PUCCH and/or the number of slots for Inter slot frequency hopping may be configured, together with L, as in Proposal 2-2. Information on configuration of the number of Repetitions of PUCCH and/or information on configuration of the number of slots for the Inter slot frequency hopping may be included in the PUCCH-Resource field.

### (Proposal 3-3)

In Proposal 3-3, Enabling/disabling is configured for each PUCCH resource, whereas L is configured for each PUCCH format. For example, the information on the Enabling/disabling configuration is included in a PUCCH resource field, and the information on the L configuration is included in a PUCCH format field. In this case, for example, Enabling/disabling is configured using the PUCCH resource field, and L is configured using the PUCCH format field.

Proposal 3-3 is different from Proposal 2-1 in that Enabling/disabling is configured using the PUCCH resource field. Meanwhile, Proposal 3-3 is common to Proposal 2-1 in that L is configured using the PUCCH format field. Hence, a description will be given with reference to FIG. 5 used in Proposal 2-1.

For example, in Proposal 3-3, the PUCCH-DMRS-Bundling field of FIG. 5 is included in a PUCCH-resource field rather than in a PUCCH-FormatConfig field. Since the PUCCH-Resource field is information on the configuration for each PUCCH resource (e.g., for each PUCCH Resource Id), Enabling/disabling is configured for each PUCCH resource by causing the PUCCH-DMRS-Bundling field to be included in the PUCCH-Resource field.

Note that, in Proposal 3-3, a PUCCH-TimeDomainWindowLength field is included in a “PUCCH format0” field, as in Proposal 2-1 (illustrated in FIG. 5). Therefore, as in Proposal 2-1, L is configured for each PUCCH format by causing the TimeDomain WindowLength field to be included in the PUCCH format field.

Meanwhile, an example of the information on the L configuration that is configured for each PUCCH format is the same as that of Proposal 2-1, and thus, the description thereof is omitted.

### (Proposal 3-4)

In Proposal 3-4, Enabling/disabling is configured for each PUCCH format, whereas L is configured for each PUCCH resource. For example, the information on the Enabling/disabling configuration is included in a PUCCH format field, and the information on the L configuration is included in a PUCCH resource field. In this case, for example, Enabling/disabling is configured using the PUCCH format field, and L is configured using the PUCCH resource field.

Proposal 3-4 is different from Proposal 2-2 in that Enabling/disabling is configured using the PUCCH format field. Meanwhile, Proposal 3-4 is common to Proposal 2-2 in that L is configured using the PUCCH resource field. Hence, a description will be given with reference to FIG. 6 used in Proposal 2-2.

For example, in Proposal 3-4, the PUCCH-DMRS-Bundling field of FIG. 6 is included in a PUCCH format field (e.g., PUCCH-format 0 field) rather than a PUCCH-FormatConfig field. The PUCCH-format 0 field is information on configuration of PUCCH format 0. Since the fields of PUCCH format 0 and another PUCCH format are information on the configuration for each PUCCH format, Enabling/disabling is configured for each PUCCH format by causing the PUCCH-DMRS-Bundling field to be included in a PUCCH format field.

Note that, in Proposal 3-4, the PUCCH-TimeDomainWindowLength field is included in a PUCCH-Resource field, as in Proposal 2-2 (illustrated in FIG. 6). Thus, as in Proposal 2-2, L is configured for each PUCCH resource by causing the TimeDomainWindowLength field to be included in the PUCCH-Resource field.

Meanwhile, an example of the information on the L configuration that is configured for each PUCCH resource is the same as that of Proposal 2-2 (illustrated in FIG. 6), and thus, the description thereof is omitted.

As described above, Proposal 3 has indicated the example in which Enabling/disabling of the DMRS bundling for PUCCH and L of the DMRS bundling for PUCCH are configured for each PUCCH format or for each PUCCH resource. This allows the PUCCH DMRS bundling to be configured, thus improving the performance of signal processing based on a DMRS. Further, the configuration for each PUCCH format or for each PUCCH resource makes it possible to perform configuration for processing of the DMRS bundling appropriately for each PUCCH format or for each PUCCH resource.

### (Proposal 4)

In Proposal 4, Enabling/disabling of the DMRS bundling for PUCCH is configured for each PUCCH format or for each PUCCH resource, whereas L is configured for each BWP.

For example, the information on the Enabling/disabling configuration is included in a PUCCH format field or a PUCCH-Resource field of a PUCCH-Config IE, and the information on the L configuration is included in a PUCCH-FormatConfig field of the PUCCH-Config IE. In this case, Enabling/disabling is configured using the PUCCH-Resource field or the PUCCH format field. Meanwhile, L is configured using the PUCCH-FormatConfig field.

Illustratively, Proposal 4 includes the following two variations:
Enabling/disabling is configured for each PUCCH format, whereas L is configured for each BWP (hereinafter referred to as Proposal 4-1); and
Enabling/disabling is configured for each PUCCH resource, whereas L is configured for each BWP (hereinafter referred to as Proposal 4-2).

The variations will be each described below.

### (Proposal 4-1)

In Proposal 4-1, Enabling/disabling is configured for each PUCCH format, whereas L is configured for each BWP. For example, the information on the Enabling/disabling configuration is included in a PUCCH format field, and L is included in a PUCCH-FormatConfig field of a PUCCH-Config IE.

Proposal 4-1 is common to Proposal 3-1 in that Enabling/disabling is configured using the PUCCH format field. Proposal 4-1 is common to Proposal 1 in that L is configured using the PUCCH-FormatConfig field of the PUCCH-Config IE. Hence, a description will be given with reference to FIG. 4 used in Proposal 1.

In Proposal 4-1, the PUCCH-DMRS-Bundling field of FIG. 4 is included in a PUCCH format field rather than a PUCCH-FormatConfig field. Therefore, as in Opt. 1 of Proposal 3-1, Enabling/disabling is configured for each PUCCH format by causing the PUCCH-DMRS-Bundling field to be included in the PUCCH format field.

Further, in Proposal 4-1, the PUCCH-TimeDomainWindowLength field is included in the PUCCH-FormatConfig field, as in Proposal 1 (illustrated in FIG. 4). Therefore, as in Proposal 1, L is configured for each BWP by causing the TimeDomainWindowLength field to be included in the PUCCH-FormatConfig field.

Meanwhile, an example of the information on the Enabling/disabling configuration that is configured for each PUCCH format is the same as that of Proposal 3-1, and thus, the description thereof is omitted. Further, an example of the information on the L configuration that is configured for each BWP is the same as that of Proposal 1, and thus, the description thereof is omitted.

### (Proposal 4-2)

In Proposal 4-2, Enabling/disabling is configured for each PUCCH resource, whereas L is configured for each BWP. For example, Enabling/disabling is configured using a PUCCH resource field, and L is configured using a PUCCH-FormatConfig field of a PUCCH-Config IE.

Proposal 4-2 is common to Proposal 3-2 in that Enabling/disabling is configured using the PUCCH resource field. Proposal 4-2 is common to Proposal 1 in that L is configured using the PUCCH-FormatConfig field of the PUCCH-Config IE. Hence, a description will be given with reference to FIG. 4 used in Proposal 1.

In Proposal 4-2, the PUCCH-DMRS-Bundling field of FIG. 4 is included in a PUCCH-resource field rather than a PUCCH-FormatConfig field. Therefore, as in Opt. 1 of Proposal 3-2, Enabling/disabling is configured for each PUCCH resource by causing the PUCCH-DMRS-Bundling field to be included in the PUCCH-resource field.

Further, in Proposal 4-2, the PUCCH-TimeDomainWindowLength field is included in the PUCCH-FormatConfig field, as in Proposal 1 (illustrated in FIG. 4). Therefore, as in Proposal 1, L is configured for each BWP by causing the TimeDomainWindowLength field to be included in the PUCCH-FormatConfig field.

Meanwhile, an example of the information on the Enabling/disabling configuration that is configured for each PUCCH resource is the same as that of Proposal 3-2, and thus, the description thereof is omitted. Further, an example of the information on the L configuration that is configured for each BWP is the same as that of Proposal 1, and thus, the description thereof is omitted.

As described above, Proposal 4 has indicated the example in which Enabling/disabling of the DMRS bundling for PUCCH is configured for each PUCCH format or for each PUCCH resource, and L is configured for each BWP. This allows the PUCCH DMRS bundling to be configured, thus improving the performance of signal processing based on the DMRS. Further, the configuration of Enabling/disabling of the DMRS bundling for PUCCH for each PUCCH resource or for each PUCCH resource makes it possible to perform configuration for processing of the DMRS bundling appropriately for each PUCCH resource or for each PUCCH resource.

### (Proposal 5: UE Capability Report)

UE 200 reports the Capability (information indicating Capability of UE 200) on support availability to the configuration of the PUCCH DMRS bundling. For example, the following information may be reported:
Whether support of the PUCCH DMRS bundling configuration is possible (e.g., whether Enable configuration is possible);
Whether support of the Time domain Window length configuration is possible (e.g. whether TDW length configuration (adjustment) is possible); and
Range of a supportable length of the Time domain Window (e.g., maximum length, minimum length, and union of supportable lengths).

Note that the above-mentioned Capability (ies) may be reported, to a frequency supported by a mobile station (e.g., UE), in any of the following manners:
Report on all frequencies at once whether support (whether support as mobile station) is possible;
Report, for each frequency, whether support is possible; and
Report, in each of FR1 and FR2, whether support is possible.

Note that the above-mentioned Capability (ies) may be reported, to a duplex scheme supported by a mobile station (e.g., UE), in any of the following manners:
Report on all duplex schemes supported by the mobile station at once whether support (whether to support as mobile station) is possible; and
Report, for each duplex scheme (e.g., for each of TDD and FDD), whether support is possible.

As described above, in the proposals in the present embodiment, the information on configuration of the DMRS bundling is appropriately indicated to UE 200 via RRC signaling, and in UE 200, the configuration of the DMRS bundling is appropriately performed, thus improving the performance of signal processing based on a reference signal.

Besides, in the above description, Enabling/disabling of the DMRS bundling for PUCCH may be configured by information on other configurations. For example, Enabling/disabling of the DMRS bundling for PUCCH may be configured by information on Enabling/disabling configuration of the DMRS bundling for PUSCH. For example, Enabling of the DMRS bundling for PUCCH may be configured based on the information that configures Enabling of the DMRS bundling for PUSCH. Alternatively, Enabling/disabling of the DMRS bundling for PUSCH may be configured by the information on the Enabling/disabling configuration of the DMRS bundling for PUCCH.

Moreover, L of the DMRS bundling for PUCCH may be configured by information on other configurations. For example, L of the DMRS bundling for PUCCH may be configured by information indicating a window length of a TDW of the DMRS bundling for PUSCH. By way of example, L of the DMRS bundling for PUCCH may be the same as the window length of the TDW of the DMRS bundling for PUSCH, or L of the DMRS bundling for PUCCH may be determined based on the window length of the TDW of the DMRS bundling for PUSCH. For example, L of the DMRS bundling for PUCCH may be a value obtained by adding an offset to the window length of the TDW of the DMRS bundling for PUSCH.

Besides, the above description has indicated an example in which at least one of the information on the Enabling/disabling configuration and the information on the L configuration are included in any one of the PUCCH-FormatConfig field, the PUCCH-Resource field, and the PUCCH format field of the PUCCH-Config IE; however, the present disclosure is not limited to this example. For example, the information on the Enabling/disabling configuration may be included in two or more fields of the PUCCH-FormatConfig field, the PUCCH-Resource field, and the PUCCH format field. In this case, the information in any of the fields may be prioritized over the information in the other fields, and configuration based on the prioritized information may be made. Which field information is prioritized may be defined by specifications or may be indicated by a UE Capability. In contrast, for example, the information on the L configuration may be included in two or more fields of the PUCCH-FormatConfig field, the PUCCH-Resource field, and the PUCCH format field. In this case, the information in any of the fields may be prioritized over the information in the other fields, and configuration based on the prioritized information may be made. Which field information is prioritized may be defined by specifications or may be indicated by a UE Capability. Alternatively, L may be configured based on information included in a plurality of fields. For example, the maximum value, the minimum value, and the mean value of the values of L of the respective fields may be configured as L.

Besides, the above description has indicated an example in which at least one of the information on the Enabling/disabling configuration and the information on the L configuration are included in any one of the PUCCH-FormatConfig field, the PUCCH-Resource field, and the PUCCH format field of the PUCCH-Config IE; however, the present disclosure is not limited to this example. For example, the information on the DMRS bundling configuration includes information that is different from the information on the Enabling/disabling configuration and the information on the L configuration. Illustratively, the information on the DMRS bundling configuration may include the information on the configuration of the number of slots for the Inter slot frequency hopping. In this case, the information on the configuration of the number of slots for the Inter slot frequency hopping may be included in any of the PUCCH-FormatConfig field, the PUCCH-Resource field, and the PUCCH format field.

Further, the term “DMRS bundling” may be replaced with the term “joint channel estimation.” For example, the Enabling/disabling configuration of the DMRS bundling for PUCCH may be replaced with Enabling/disabling configuration of the joint channel estimation for PUCCH.

Further, the above-described term “Enabling” may be replaced with other terms such as “valid” and “configurable,” whereas the term “disabling” may be replaced with other terms such as “invalid” and “not configurable.”

Further, the designation of a field included in the above-described PUCCH-config 1E is exemplary, and the present disclosure is not limited to this example. The information on the Enabling/disabling configuration of the DMRS bundling for PUCCH may correspond to a field with a designation different from the “PUCCH-DMRS-Bundling” field, and the information on the L configuration of the DMRS bundling for PUCCH may correspond to a field with a designation different from the “PUCCH-TimeDomainWindowLength” field.

Further, the information on the Enabling/disabling configuration of the DMRS bundling for PUCCH and/or the information on the L configuration of the DMRS bundling for PUCCH may be included in an information element different from a PUCCH-config 1E, or may be indicated by an indication method (e.g., DCI or MAC CE) different from RRC signalling.

Incidentally, in the above description, the DMRS bundling configuration for PUCCH has been taken as an example; however, the present disclosure is not limited to this example. For example, the present disclosure may be applied to bundling configuration of a DMRS of PUCCH and a DMRS of PUSCH. Alternatively, the present disclosure may be applied to bundling of two or more various reference signals (e.g., PTRS and SRS) including a DMRS of PUCCH.

Further, in the above description, an example in which the DMRS bundling for PUCCH is performed over (across) a plurality of slots; however, the present disclosure is not limited to this example. For example, the DMRS bundling may be applied to units (e.g., frames or sub-frames) different from the slots. Further, the DMRS bundling may be applied to processing units different from the processing units in the time direction. For example, the DMRS bundling may be applied to processing units in the frequency direction (e.g., resource blocks).

Further, in the above description, the DMRS bundling for PUCCH, which is an uplink control channel, has been taken as an example; however, the present disclosure is not limited to this example. For example, the present disclosure may be applied to the DMRS bundling for PDSCH, which is a downlink data channel, and/or the DMRS bundling for PDCCH, which is a downlink control channel. In this case, the information on the Enabling/disabling configuration of the DMRS bundling and/or the information on the L configuration of the DMRS bundling may be included in information on downlink channel configuration (e.g., information on configuration(s) of PDSCH and/or PDCCH).

Next, configurations of base station 100 (gNB 100) and terminal 200 (UE 200) will be described. Note that the configurations of base station 100 and terminal 200 described below illustrate examples of functions related to the present embodiment. Base station 100 and terminal 200 may have functions that are not illustrated. Further, functional classification and/or names of functional sections are/is not limited as long as the functions serve for executing operations according to the present embodiment.

### <Configuration of Base Station>

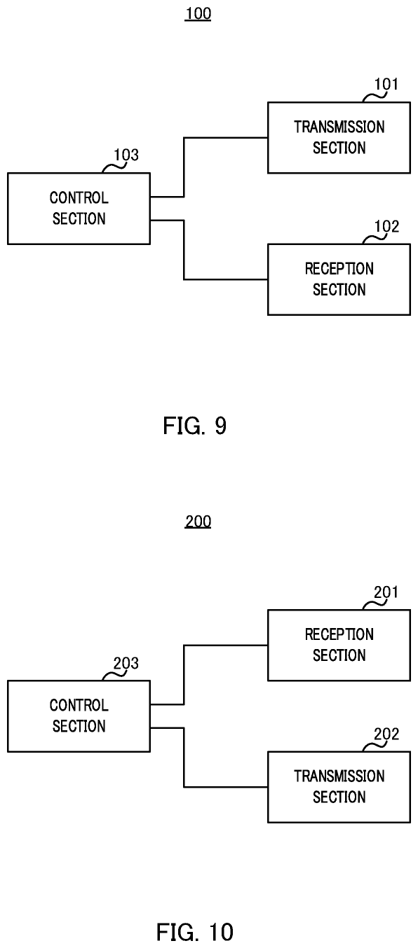

FIG. 9 is a block diagram illustrating an exemplary configuration of base station 100 according to the present embodiment. Base station 100 includes, for example, transmission section 101, reception section 102, and control section 103. Base station 100 communicates wirelessly with terminal 200 (see FIG. 10).

Transmission section 101 transmits a downlink (DL) signal to terminal 200. For example, transmission section 101 transmits the DL signal under the control of control section 103.

The DL signal may include, for example, a downlink data signal and control information (e.g., Downlink Control Information (DCI)). The signal including the control information may be referred to as a control signal. The DL signal may also include information (e.g., UL grant) indicating scheduling related to signal transmission of terminal 200. Moreover, the DL signal may include higher layer control information (e.g., Radio Resource Control (RRC) control information). For example, higher layer signaling (e.g., RRC signaling or Media Access Control Control Element (MAC CE)) may be regarded as an example of the DL signal. Furthermore, the DL signal may include a reference signal.

Channels used for DL signal transmission include, for example, a data channel and a control channel. For example, the data channel may include a Physical Downlink Shared Channel (PDSCH), and the control channel may include a Physical Downlink Control Channel (PDCCH). For example, base station 100 transmits control information to terminal 200 using PDCCH and transmits a downlink data signal using PDSCH.

The reference signal included in the DL signal may include, for example, at least one of a Demodulation Reference Signal (DMRS), a Phase Tracking Reference Signal (PTRS), a Channel State Information-Reference Signal (CSI-RS), a Sounding Reference Signal (SRS), and a Positioning Reference Signal (PRS) for position information. For example, the reference signal such as the DMRS and the PTRS is used for demodulation of a downlink data signal and is transmitted using PDSCH.

Reception section 102 receives an uplink (UL) signal transmitted from terminal 200. For example, reception section 102 receives the UL signal under the control of control section 103.

Control section 103 controls communication operations of base station 100 including transmission processing in transmission section 101 and reception processing in reception section 102.

By way of example, control section 103 acquires information such as data and control information from a higher layer and outputs the data and control information to transmission section 101. Further, control section 103 outputs the data, the control information, and/or the like received from reception section 102 to the higher layer.

For example, control section 103 allocates a resource (or channel) used for DL signal transmission and reception and/or a resource used for UL signal transmission and reception, based on the signal (e.g., data, control information and/or the like) received from terminal 200 and/or the data, the control information, and/or the like acquired from the higher layer. Information on the allocated resource(s) may be included in control information to be transmitted to terminal 200.

Control section 103 configures a PUCCH resource as an example of the allocation of the resource used for UL signal transmission and reception. Information on the PUCCH configuration such as a PUCCH cell timing pattern (PUCCH configuration information) may be indicated to terminal 200 by RRC. As described above, the information on the PUCCH configuration may include the information on the Enabling/disabling configuration of the DMRS bundling and/or the information on the L configuration of the DMRS bundling.

Control section 103 may also perform, in reception processing of an UL signal, Joint Channel estimation that uses DMRSs over (across) a plurality of slots. Note that uplink reception processing (e.g., Joint Channel estimation) related to the DMRS bundling is not limited to the above-described example.

### <Configuration of Terminal>

FIG. 10 is a block diagram illustrating an exemplary configuration of terminal 200 according to the present embodiment. Terminal 200 includes, for example, reception section 201, transmission section 202, and control section 203. Terminal 200 communicates wirelessly with, for example, base station 100.

Reception section 201 receives a DL signal transmitted from base station 100. For example, reception section 201 receives the DL signal under the control of control section 203.

Transmission section 202 transmits an UL signal to base station 100. For example, transmission section 202 transmits the UL signal under the control of control section 203.

The UL signal may include, for example, an uplink data signal and control information (e.g., UCI). For example, information on processing capability of terminal 200 (e.g., UE capability) may also be included. Further, the UL signal may include a reference signal.

Channels used for UL signal transmission include, for example, a data channel and a control channel. For example, the data channel includes a Physical Uplink Shared Channel (PUSCH), and the control channel includes a Physical Uplink Control Channel (PUCCH). For example, terminal 200 receives control information from base station 100 using PUCCH and transmits an uplink data signal using PUSCH.

The reference signal included in the UL signal may include, for example, at least one of a DMRS, a PTRS, a CSI-RS, an SRS, and a PRS. For example, the reference signal such as the DMRS and the PTRS is used for demodulation of an uplink data signal and is transmitted using an uplink channel (e.g., PUSCH).

Control section 203 controls communication operations of terminal 200 including reception processing in reception section 201 and transmission processing in transmission section 202.

By way of example, control section 203 acquires information such as data and control information from a higher layer and outputs the data and control information to transmission section 202. Further, control section 203 outputs, for example, the data, the control information, and/or the like received from reception section 201 to the higher layer.

For example, control section 203 controls transmission of information to be fed back to base station 100. The information to be fed back to base station 100 may include, for example, HARQ-ACK, Channel State Information (CSI), and a Scheduling Request (SR). The information to be fed back to base station 100 may be included in the UCI. The UCI is transmitted with a PUCCH resource.

Control section 203 configures a PUCCH resource based on the configuration information (e.g., information such as PUCCH configuration indicated by RRC, and/or DCI) received from base station 100 Control section 203 determines a PUCCH resource used for transmitting the information to be fed back to base station 100.

Further, control section 203 executes control related to the DMRS bundling, based on the configuration information received from base station 100. For example, when the information on Enabling/disabling configuration indicates Enabling, control section 203 may assign DMRSs to multiple slots and thus execute control of transmitting the DMRSs assigned to (over) the multiple slots. Alternatively, control section 203 may assign DMRSs to L slots, based on a value indicated by the information on the L configuration of the DMRS bundling. Note that uplink transmission processing related to the DMRS bundling is not limited to the above-described example.

Under the control of control section 203, transmission section 202 transmits the information to be fed back to base station 100, with the PUCCH resource determined by control section 203.

In the above-mentioned configuration, in terminal 200, reception section 201 receives control information (e.g., indication by RRC signaling), for example. Control section 202 then controls, based on the control information, transmission of an uplink control signal (PUCCH signal) including a reference signal (e.g., DMRS) that is mapped over a plurality of transmission time units (e.g., a plurality of slots).

Incidentally, the control information includes at least one of first information on whether a reference signal mapped over the plurality of transmission time units can be transmitted (e.g., information on Enabling/disabling configuration) and second information on the number of transmission time units (e.g., information on L configuration). Further, the control information configures at least one of the first information and the second information for each bandwidth (e.g., BWP) of a signal. Alternatively, the control information configures at least one of the first information and the second information for each format of an uplink control signal (e.g., PUCCH format). Alternatively, the control information configures at least one of the first information and the second information for each resource for the uplink control signal (e.g., PUCCH resource).

Note that, the channels used for DL signal transmission and the channels used for UL signal transmission are not limited to the examples mentioned above. For example, the channels used for the DL signal transmission and the channels used for the UL signal transmission may include a Random Access Channel (RACH) and a Physical Broadcast Channel (PBCH). The RACH may be used for, for example, transmission of Downlink Control Information (DCI) including a Random Access Radio Network Temporary Identifier (RA-RNTI).

The present disclosure has been described, thus far.

<Hardware Configuration and/or the Like>

Note that, the block diagrams used to describe the embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit,” “transmission section,” or “transmitter.” The methods for implementing the functions are not limited specifically as described above.

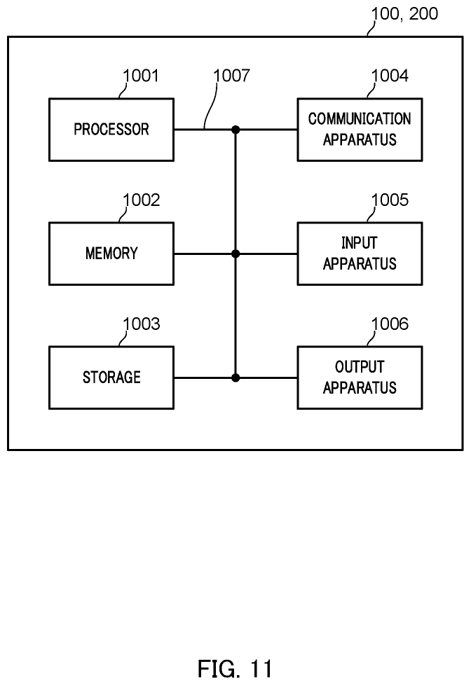

For example, the base station, the terminal, and the like according to an embodiment of the present disclosure may function as a computer that executes processing of a radio communication method of the present disclosure. FIG. 11 illustrates an exemplary hardware configuration of the base station or the terminal according to the present embodiment. Base station 100 and terminal 200 mentioned above may be each physically constituted as a computer apparatus including processor 1001, memory 1002, storage 1003, communication apparatus 1004, input apparatus 1005, output apparatus 1006, bus 1007, and the like.

Note that, the term “apparatus” in the following description can be replaced with a circuit, a device, a unit, or the like. The hardware configuration of base station 100 or terminal 200 may include one apparatus or a plurality of apparatuses illustrated in the drawings, or may not include part of the apparatuses.

The functions of base station 100 and terminal 200 are implemented by predetermined software (program) loaded into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 103, control section 203, and the like described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control section 203 of terminal 200 may be implemented by a control program stored in memory 1002 and operated by a control program operating in processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to one embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and radio networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission section 101, reception section 102, reception section 201, transmission section 202, and the like described above may be realized by communication apparatus 1004.

Input apparatus 1005 is an input device (e.g., a keyboard, a mouse, a microphone, a switch, a button, or a sensor) that receives input from the outside. Output apparatus 1006 is an output device (e.g., a display, a speaker, or an LED lamp) which makes outputs to the outside. Note that input apparatus 1005 and output apparatus 1006 may be integrated (e.g., a touch panel).

The apparatuses, such as processor 1001, memory 1002, and the like are connected by bus 1007 for communication of information. Bus 1007 may be configured using a single bus or using buses different between each pair of the apparatuses.

Furthermore, base station 100 and terminal 200 may include hardware, such as a microprocessor, a digital signal processor (DSP), an ASIC (Application Specific Integrated Circuit), a PLD (Programmable Logic Device), and an FPGA (Field Programmable Gate Array), and the hardware may implement part or all of the functional blocks. For example, processor 1001 may be implemented using at least one of these pieces of hardware.

### <Notification and Signaling of Information>

The notification of information is not limited to the embodiment described in the present disclosure, and the information may be notified by another method. For example, the notification of information may be carried out by one or a combination of physical layer signaling (e.g., Downlink Control Information (DCI) and Uplink Control Information (UCI)), higher layer signaling (e.g., Radio Resource Control (RRC) signaling, Medium Access Control (MAC) signaling, broadcast information (Master Information Block (MIB), and System Information Block (SIB))), and other signals. The RRC signaling may be called an RRC message and may be, for example, an RRC connection setup message, an RRC connection reconfiguration message, or the like.

### <Applied System>

The embodiments described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

<Processing Procedure and/or the Like>

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

### <Operation of Base Station>

Specific operations which are described in the present disclosure as being performed by the base station may sometimes be performed by a higher node (upper node) depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (e.g., MME and S-GW).

### <Direction of Input and Output>

The information or the like (see the item of “Information and Signals”) can be output from a higher layer (or a lower layer) to a lower layer (or a higher layer). The information, the signals, and the like may be input and output through a plurality of network nodes.

### <Handling of Input and Output Information and the Like>

The input and output information and the like may be saved in a specific place (e.g., memory) or may be managed using a management table. The input and output information and the like can be overwritten, updated, or additionally written. The output information and the like may be deleted. The input information and the like may be transmitted to another apparatus.

### <Determination Method>

The determination may be made based on a value expressed by one bit (0 or 1), based on a Boolean value (true or false), or based on comparison with a numerical value (e.g., comparison with a predetermined value).

### <Variations and the Like of Aspects>

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### <Software>

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

### <Information and Signals>

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### <System and Network>

The terms “system” and “network” used in the present disclosure can be interchangeably used.

### <Names of Parameters and Channels>

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (e.g., PUCCH and PDCCH) and information elements, can be identified by any suitable names, and various names assigned to these various channels and information elements are not limitative in any respect.

### <Base Station>

The terms “Base Station (BS),” “radio base station,” “fixed station,” “NodeB,” “eNodeB (eNB),” “gNodeB (gNB),” “access point,” “transmission point,” “reception point, “transmission/reception point,” “cell,” “sector,” “cell group,” “carrier,” “component carrier,” and the like may be used interchangeably in the present disclosure. The base station may be called a macro cell, a small cell, a femtocell, or a pico cell.

The base station can accommodate one cell or a plurality of (e.g., three) cells. When the base station accommodates a plurality of cells, the entire coverage area of the base station can be divided into a plurality of smaller areas, and each of the smaller areas can provide a communication service based on a base station subsystem (e.g., small base station for indoor remote radio head (RRH)). The term “cell” or “sector” denotes part or all of the coverage area of at least one of the base station and the base station subsystem that perform the communication service in the coverage.

### <Mobile Station>

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or by some other appropriate terms.

### <Base Station/Mobile Station>

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the terminal. For example, the embodiment of the present disclosure may find application in a configuration that results from replacing communication between the base station and the terminal with communication between multiple terminals (such communication may, e.g., be referred to as device-to-device (D2D), vehicle-to-everything (V2X), or the like). In this case, terminal 200 may be configured to have the functions that base station 100 described above has. The wordings “uplink” and “downlink” may be replaced with a corresponding wording for inter-equipment communication (e.g., “side”). For example, an uplink channel, a downlink channel, and the like may be replaced with a side channel.

Similarly, the terminal in the present disclosure may be replaced with the base station. In this case, base station 100 is configured to have the functions that terminal 200 described above has.

### <Meaning and Interpretation of Terms>

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### <Reference Signal>

The reference signal can also be abbreviated as an RS and may also be called as a pilot depending on the applied standard.

### <Meaning of “Based On”>

The description “based on” used in the present disclosure does not mean “based only on,” unless otherwise specified. In other words, the description “based on” means both of “based only on” and “based at least on.”

### <“First” and “Second”>

Any reference to elements by using the terms “first,” “second,” and the like does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### <“Means”>

The “means” in the configuration of each apparatus may be replaced with “section,” “circuit,” “device,” or the like.

### <Open-Ended Format>

In a case where terms “include,” “including,” and their modifications are used in the present disclosure, these terms are intended to be inclusive like the term “comprising.” Further, the term “or” used in the present disclosure is not intended to be an exclusive or.

### <Time Units Such as a TTI, Frequency Units Such as an RB, and a Radio Frame Configuration>

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (e.g., 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are used in each user terminal) on a TTI-by-TTI basis to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

### <Maximum Transmit Power>

The “maximum transmit power” described in the present disclosure may mean a maximum value of the transmit power, the nominal UE maximum transmit power, or the rated UE maximum transmit power.

### <Articles>

In a case where articles, such as “a,” “an,” and “the” in English, for example, are added in the present disclosure by translation, nouns following these articles may have the same meaning as used in the plural.

### <“Different”>

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### INDUSTRIAL APPLICABILITY

An aspect of the present disclosure is useful for radio communication systems.

### REFERENCE SIGNS LIST

100 Base station (gNB)
200 Terminal (UE)
101, 202 Transmission section
102, 201 Reception section
103, 203 Control section

1. A terminal, comprising:
a reception section that receives control information; and
a control section that controls, based on the control information, transmission of an uplink control signal that includes a reference signal mapped over a plurality of transmission time units.

2. The terminal according to claim 1, wherein the control information includes at least one of first information and/or second information, the first information being on whether the reference signal mapped over the plurality of transmission time units is transmittable, the second information being on a number of the transmission time units.

3. The terminal according to claim 2, wherein the control information configures at least one of the first information and/or the second information for each bandwidth of a signal.

4. The terminal according to claim 2, wherein the control information configures at least one of the first information and/or the second information for each format of the uplink control signal.

5. The terminal according to claim 2, wherein the control information configures at least one of the first information and/or the second information for each resource for the uplink control signal.

6. A radio communication method, comprising:
receiving control information by a terminal; and
controlling, by the terminal based on the control information, transmission of an uplink control signal that includes a reference signal mapped over a plurality of transmission time units.
